(19) United States
(12) Patent Application Publication
(10) Pub. No.: US 2026/0321679 A1
(43) Pub. Date: Oct. 15, 2026

(54) CARBON FABRIC WITH A MICROPOROUS LAYER FOR USE IN FUEL CELLS

(71) Applicant: OBA PERDESAN TEKNIK TEKSTIL ANONIM SIRKETI, Istanbul (TR)

(72) Inventor: Alp Yaman ALTUG, Istanbul (TR)

(73) Assignee: OBA PERDESAN TEKNIK TEKSTIL ANONIM SIRKETI, Istanbul (TR)

(21) Appl. No.: 18/858,357

(22) PCT Filed: Apr. 1, 2024
(86) PCT No.: PCT/TR2024/050330

§ 371 Date: Oct. 21, 2024

(30) Foreign Application Priority Data
Dec. 6, 2023 (TR) 2023/016617

(51) Int. Cl. H01M 4/88; D06M 11/74; D06M 15/256; D06M 15/263; D06M 101/40

(52) U.S. Cl. CPC H01M 4/8807; D06M 11/74; D06M 15/256; D06M 15/263; D06M 2101/40; D10B 2101/12

(57) ABSTRACT

The invention relates to a carbon fabric with a microporous layer for use in fuel cells. The fabric of the invention is coated with a microporous layer and has a high gas diffusion capacity and water conductivity and is used as a gas diffusion layer.

### TECHNICAL FIELD OF THE INVENTION

The invention relates to a carbon fabric with a microporous layer for use in fuel cells, especially low-temperature fuel cells. In the fabric of the invention, the macropores on the surface are coated with a microporous layer and have a high gas diffusion capacity and water conductivity and are used as a gas diffusion layer.

### STATE OF THE ART

Fossil fuels are energy sources occurring upon decomposition of the remains of living organisms (the remains of animals and plants) under the ground for millions of years. They are formed as a result of fossilization of the remains of the living organisms in airless environments in the layers of the earth's crust at high pressures. 63.7 percent of the world's fossil fuel reserves are coal, 18.2 percent are oil and 18.1 percent are natural gas. However, traditional fossil fuel energy which causes various problems, such as air pollution, deterioration of natural life and melting of polar ice caps, especially climate change, and damage to the environment, is considered to have low efficiency worldwide. Therefore, the development of efficient and clean energy sources is generally the common idea of all countries.

Renewable fuel cells, which use hydrogen, methane, methanol, ethanol and other clean energies [1], use fuels and oxygen (or air) to directly release the electrical energy through the electrochemical reactions. Unlike secondary batteries which need to be recharged, the fuel cells may continuously generate electricity as long as there is a source of fuel and oxygen, making fuel cells superior to the intermittent behavior of the other renewable energy sources such as solar and wind power. In addition, the efficiency of fuel cells is much higher than the other energy generation systems as there is no heat exchange and mechanical conduction process. Depending on the difference in electrolytes, the fuel cells are mainly classified into alkaline fuel cells (AFCs), molten carbonate fuel cells (MCFCs), proton exchange membrane fuel cells (PEMFCs), solid oxide fuel cells (SOFCs), and phosphoric acid fuel cells (PAFCs). Among them, PEMFCs are technically highly advanced and commercially available. PEMFCs mainly use perfluorinated polymers (e.g., Nafion) and consequently are intolerant of high temperature; they typically operate at around 80° C. In proton exchange membrane fuel cells, the chemical energy is converted directly into the electrical energy, while water is released at the cathode as a by-product. If the released water is not removed from the cathode, water accumulates and the performance and efficiency of the fuel cell decreases. In this sense, the gas diffusion layer (GDL) of the carbon fabric, which is used for water management and homogeneous distribution of gases, becomes important. GDL is a fibrous porous medium located between the anode and cathode electrodes, which has two main functions to ensure the uniform distribution of the reactive gases on the surface of the electrodes and the transport of the electrons to or from an external electrical circuit. GDLs generally consist of two different layers, a MPS (a Macroporous substrate) and a MPL (a Microporous substrate). Thus, the MPS provides a mechanical support, an excellent electrical conductivity and gas permeability for the GDL, while the MPL facilitates the gas distribution to the active sites in the catalyst layer due to the microporosity thereof [2]. The porosity and electrical conductivity of the activated carbon/graphite in the GDL structure are important for determining the product performance. While a polymeric coating process (PTFE, PMMA, PVDF, etc.) is performed as a pre-treatment to provide water management, the ratio of the coating to be used also affects the porosity and water management of the GDL. In addition, the alcohol ratio used in the content is also among the factors affecting the pore size of the GDL. Therefore, the optimization of the recipe and process parameters of the gas diffusion layer of the carbon fabric is of great importance. In particular, it is preferred that the amount of polymer used is at a level that does not reduce the electrical conductivity of the carbon fabric in order to reduce the resistance losses, because if the amount of polymer is low, it is not possible to use it as the shedding will occur in the carbons that make up the microporous structure.

Due to the limitations and inabilities of the solutions in the state of the art, it has been necessary to make an improvement in the carbon fabrics used in fuel cells caused by the low gas diffusion capacity and electrical and water conductivity of the gas diffusion layers of the carbon fabric, the low efficiency of the fuel cells, the poor mechanical strength, and the inability to use some fabrics due to the amount of polymer.

### SUMMARY AND OBJECTS OF THE INVENTION

The invention describes a carbon fabric with a microporous layer for use in fuel cells. In the fabric of the invention, the macropores on the surface are coated with a microporous layer and have a high gas diffusion capacity and water conductivity.

The object of the invention is to increase the energy efficiency in fuel cells. The carbon fabric of the invention has a high gas diffusion capacity, and an electrical and water conductivity. Said fabric is passed through a polymer-based solvent for hydrophobicity before coating. In this way, the water formed as a result of the electrochemical reaction is removed from the environment, and the performance of the fuel cell increases.

Another object of the invention is to minimize the mass transfer losses. The surface of the fabric of the invention is hydrophobic and thus, the accumulation of water released as a result of the electrochemical reactions of the fuel cell in the active site is prevented, thereby the mass transfer losses being minimized.

### DETAILED DESCRIPTION OF THE INVENTION

The invention relates to a carbon fabric with a microporous layer for use in fuel cells. The fabric of the invention is coated with a microporous layer and has a high gas diffusion capacity and water conductivity and is used as a gas diffusion layer (GDL). The carbon fabric of the invention contains 5-60% (w/w) by mass, optimally 15%, of a polymer coating. Said polymer coating contains 5-70% by mass of a binding polymer, 20-90% by mass of carbon black or 20-90% by mass of the activated carbon, or 5-60% by mass of graphite or reduced graphene oxide (rGO). Polytetrafluoroethylene (PTFE), polyvinylidene fluoride (PVDF) or polymethyl methacrylate (PMMA) are used as the binding polymers. The fabric of the invention is suitable for use in the automotive, energy, and aeronautics and space sectors, as well as in secondary energy storage systems.

A production method of a carbon fabric with a macroporous layer for use in fuel cells of the invention comprises the following process steps:
i. removing any contaminants or foreign substances on the fabric by washing or solvent cleaning,
ii. preparing a solution with the binding polymer and carbon black, the activated carbon, graphite, or reduced graphene oxide (rGO),
iii. coating the solution prepared on the fabric by knife coating, dip coat, air brush, immersion coating, spray coating, or roll coating,
iv. evaporating the solvent in the coating solution to obtain a microporous structure,
v. passing the coated fabric through the heated rollers under pressure in order to homogenize, and increase the density of, the microporous layer.

In another embodiment of the invention, the production method of a carbon fabric with a macroporous layer for use in the fuel cells of the invention comprises the following process steps:
i. removing any contaminants or foreign substances on the fabric by washing or solvent cleaning,
ii. preparing a solution with 5-70% by mass of a binding polymer and 20-90% by mass of carbon black or 20-90% by mass of activated carbon, or 5-60% by mass of graphite or reduced graphene oxide (rGO),
iii. coating the solution prepared on the fabric by knife coating, dip coat, air brush, immersion coating, spray coating, or roll coating,
iv. evaporating the solvent in the coating solution to obtain a microporous structure,
v. passing the coated fabric through the heated rollers under pressure in order to homogenize, and increase the density of, the microporous layer.

Said binding polymer in step (ii) of the method of the invention is polytetrafluoroethylene (PTFE), polyvinylidene fluoride (PVDF), or polymethyl methacrylate (PMMA).

The electrical resistance provided by the carbon fabric of the invention in fuel cells is 40 mohm·cm², and the gas diffusion capacity is 350 ml/min/cm² . In addition, the water permeability is 0.5 mg/cm²·s. The performance of said fabric in the fuel cell is such that a current density of 1 ampere/cm2 is reached at 0.6 volts and there is a 5% performance loss at the end of 3000 hours. cl INDUSTRIAL APPLICABILITY OF THE INVENTION

The invention relates to a carbon fabric with a microporous layer for use in fuel cells and has industrial applicability.

The invention is not limited to the foregoing exemplary explanations, and one person skilled in the art may easily reveal the different embodiments of the invention. These should be considered within the scope of protection of the invention claimed in the claims.

### REFERENCES

[1] Krishnan, S.; Armstrong, F. A. Order-of-magnitude enhancement of an enzymatic hydrogen-air fuel cell based on pyrenyl carbon nanostructures. Chem. Sci. 2012, 3, 1015-1023.
[2] Navarro, A. J., Gómez, M. A., Daza, L., & López-Cascales, J. J. (2022, Mar. 10). Production of gas diffusion layers with cotton fibers for their use in fuel cells. Nature News. https://www.nature.com/articles/s41598-022-08124-0

1. A carbon fabric with a microporous layer for use as a gas diffusion layer (GDL) in fuel cells, characterized in that it contains a polymer coating of 5-60% (w/w) by mass.

2. A fabric according to claim 1, characterized in that said polymer coating contains 5-70% by mass of a binding polymer, 20-90% by mass of a carbon black or 20-90% by mass of an activated, or 5-60% by mass of graphite or reduced graphene oxide (rGO).

3. A fabric according to claim 2, characterized in that said binding polymer is polytetrafluoroethylene (PTFE), polyvinylidene fluoride (PVDF), or polymethyl methacrylate (PMMA).

4. A production method of a fabric according to claim 1, characterized in that it comprises the following process steps:
i. removing any contaminants or foreign substances on the fabric by washing or solvent cleaning,
ii. preparing a solution with the binding polymer and carbon black, the activated carbon or reduced graphene oxide (rGO),
iii. coating the solution prepared on the fabric by knife coating, dip coat, air brush, immersion coating, spray coating, or roll coating,
iv. evaporating the solvent in the coating solution to obtain a microporous structure,
v. passing the coated fabric through the heated rollers under pressure in order to homogenize, and increase the density of, the microporous layer.

5. A method according to claim 4, characterized in that it comprises the following process steps:
i. removing any contaminants or foreign substances on the fabric by washing or solvent cleaning,
ii. preparing a solution with 5-70% by mass of a binding polymer and 20-90% by mass of carbon black or 20-90% by mass of activated carbon, or 5-60% by mass of graphite or reduced graphene oxide (rGO),
iii. coating the solution prepared on the fabric by knife coating, dip coat, air brush, immersion coating, spray coating, or roll coating,
iv. evaporating the solvent in the coating solution to obtain a microporous structure,
v. passing the coated fabric through the heated rollers under pressure in order to homogenize, and increase the density of, the microporous layer.

6. A method according to claim 4 or 5, characterized in that said binding polymer in step (ii) is polytetrafluoroethylene (PTFE), polyvinylidene fluoride (PVDF), or polymethyl methacrylate (PMMA).

7. A carbon fabric with a microporous layer produced by a method according to claim 4 for use as a gas diffusion layer in fuel cells.
